(19) United States
(12) Patent Application Publication
(10) Pub. No.: US 2002/0120527 A1
(43) Pub. Date: Aug. 29, 2002

(54) Method and system for international shopping

(76) Inventors: Benson Lam, Mississauga (CA); Chee Ng, Don Mills (CA); Gregory Yu, Toronto (CA); Andrew Trossman, Toronto (CA); Teck Yong, Vaughan (CA); Katherine Yaphe, Toronto (CA); Pierre Schuurmans, Toronto (CA); Florin Mihaila, Toronto (CA); Nicolae Vintila, North York (CA)

Correspondence Address: Breiner & Breiner, L.L.C., P.O. Box 19290, Alexandria, VA, 22320-0290, US

(21) Appl. No.: 09/911,573

(22) Filed: Jul. 25, 2001

Related U.S. Application Data
(60) Provisional application No. 60/221,125, filed on Jul. 27, 2000.
(60) Provisional application No. 60/221,141, filed on Jul. 27, 2000.

(51) Int. Cl. G06F 17/60

(52) U.S. Cl. 705/26

(57) ABSTRACT

Presented is a system and method for determining a total cost of a foreign originating product in a customer's local currency. The system allows a customer to shop via electronic methods regardless of a merchant's location country and receive the total final cost of the product in the customer's local currency. Currency exchange, duties and tariffs, taxes and shipping are included in the given total cost of the product. The system also includes a duty estimation system for estimating duty charges prior to a product crossing an international border is disclosed. The product is categorized according to product categories set by each country. Based on the most frequent countries of origin of that particular product category and duty charges for these countries, a weighted average duty rate is determined and applied to the local currency value for duty cost of the product

### CROSS REFERENCE TO RELATED APPLICATIONS

The present invention claims priority from U.S. provisional patent application serial No. 60/221,125 and 60/221,141, both of which were filed on Jul. 27, 2000. United States patent application entitled “Universal Shopping Basket” claiming priority from U.S. provisional patent application serial number 60/221,126 filed concurrently herewith.

### FIELD OF THE INVENTION

The present invention relates to the field of electronic commerce. More specifically, the present invention relates to a system for assisting international electronic commerce.

### BACKGROUND OF THE INVENTION

Purchasing products through electronic methods (i.e. electronic commerce) is becoming increasingly more common as consumers realize the convenience of shopping at multiple electronic stores 24 hours a day from a single physical location. Electronic commerce has enlarged the modern marketplace where importing products was already common. Purchasing products from foreign countries should no longer be significantly different from purchasing domestic products due to the ease with which electronic commerce methods cross international borders. The difference between purchasing foreign and domestic products is often the accuracy with which the final cost of a product is given by a merchant.

Currency exchange rates vary during a business day. Credit card companies do not vary their exchange rates with currency ratios but rather change their exchange rates only periodically. Further, the exchange rate used by the credit card company is not necessarily exactly the value of the local dollar as a premium is often added for commercial exchange rates.

While there are a few electronic commerce merchants that try to serve foreign customers, their methods are limited to only a few foreign countries. For example, Vision Direction (www.vision-direct.com) offers mirror electronic commerce websites for Canadians, Americans and British, offering their products in either Canadian dollars, American dollars or British Pounds. However, very few merchants offer this service due to the extra effort required to offer products in a variety of currencies and the complexities and cost of offering mirrored systems.

The electronic commerce systems that do offer products in a number of different currencies do not calculate any duty or tariff charges that may be incurred as a result of the product crossing international borders. Duty and tariff charges are determined only as the product crosses the borders, before which time these charges are not known by the customer. As a result, duty and tariffs are frequently charged on delivery and must be paid before a customer can receive the purchased product. This causes uncertainty in the total cost of the product at the time of purchase and complicates trans-border shopping as customers must anticipate paying duty and tariffs when the product arrives.

### SUMMARY OF THE INVENTION

Accordingly, it is an object of the present invention to provide a system for determining a total cost of a foreign originating product in a customer's local currency.

In accordance with one aspect of the present invention there is provided an international shopping system in communication with an electronic commerce system operating in a first currency and offering a product for purchase, the international shopping system providing a cost in a second currency for the product to be imported into a destination country, the international shopping system comprising: an input/output interface for receiving a request for the cost of the product in the second currency and providing the cost of the product in the second currency in response to the request; a commerce system interface to the electronic commerce system for obtaining information about the product in response to the request; a product cost calculation system comprising: quote processor for establishing the cost in the second currency for the product to be imported; and an importing cost determination module in communication with the quote processor for determining an import cost for the product to be imported into the destination country based on information about the product obtained from the electronic commerce system, the importing cost determination module providing the quote processor with the import cost.

In accordance with another aspect of the present invention there is provided a method for providing a cost in a second currency of a product being imported into a destination country, the product being offered for sale by an electronic commerce system operating in a first currency, the method comprising: receiving a request for the cost of the product in the second currency; obtaining information about the product from the electronic commerce system; determining an import cost for the product to be imported into the destination country based on information about the product obtained from the electronic commerce system; establishing a total cost for the product in the second currency; and providing the cost of the product in the second currency.

In accordance with a further aspect of the present invention there is provided a computer readable medium having stored thereon computer-executable instructions for providing a cost in a second currency of a product being imported into a destination country, the product being offered for sale by an electronic commerce system operating in a first currency, the computer-executable instructions performing the steps comprising: receiving a request for the cost of the product in the second currency; obtaining information about the product from the electronic commerce system; determining an import cost for the product to be imported into the destination country based on information about the product obtained from the electronic commerce system; establishing a total cost for the product in the second currency; and providing the cost of the product in the second currency.

### BRIEF DESCRIPTION OF THE DRAWINGS

FIG. 1A is a diagram of an electronic commerce system incorporating an international shopping system according to the present invention;

FIG. 1B is a diagram of an electronic commerce system incorporating an international shopping system according to the present invention;

FIG. 1C is a diagram of an electronic commerce system incorporating an international shopping system according to the present invention;

FIG. 2 is an architectural diagram of an electronic commerce system incorporating an international shopping system according to the present invention;

FIG. 3 is a flow diagram for the electronic commerce system of FIG. 2;

FIG. 4 is a system diagram of the international shopping system according to an embodiment of the present invention;

FIG. 5 is a flow diagram for the international shopping system illustrating a quote request;

FIG. 6 is a system diagram of the duty engine according to an embodiment of the present invention; and

FIG. 7 is a flow diagram for the duty engine illustrating a duty estimation process.

### DETAILED DESCRIPTION

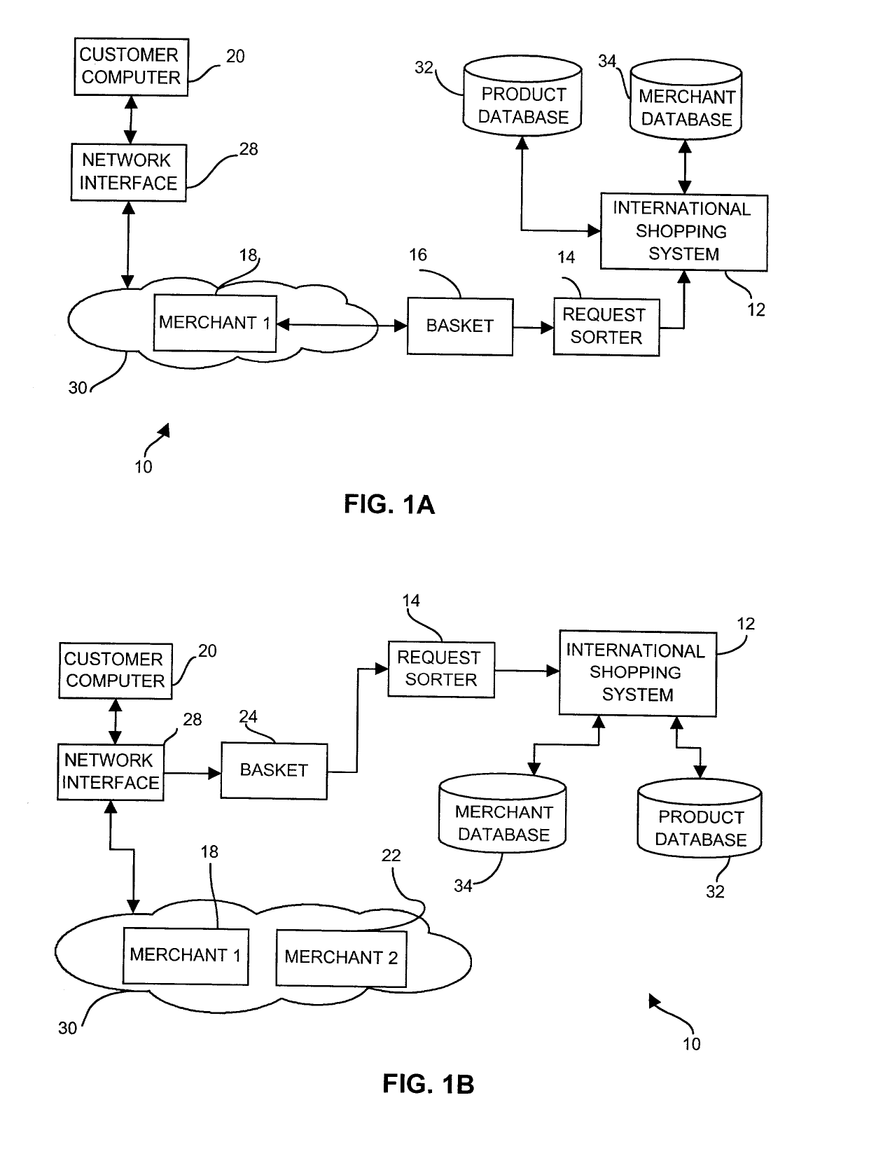

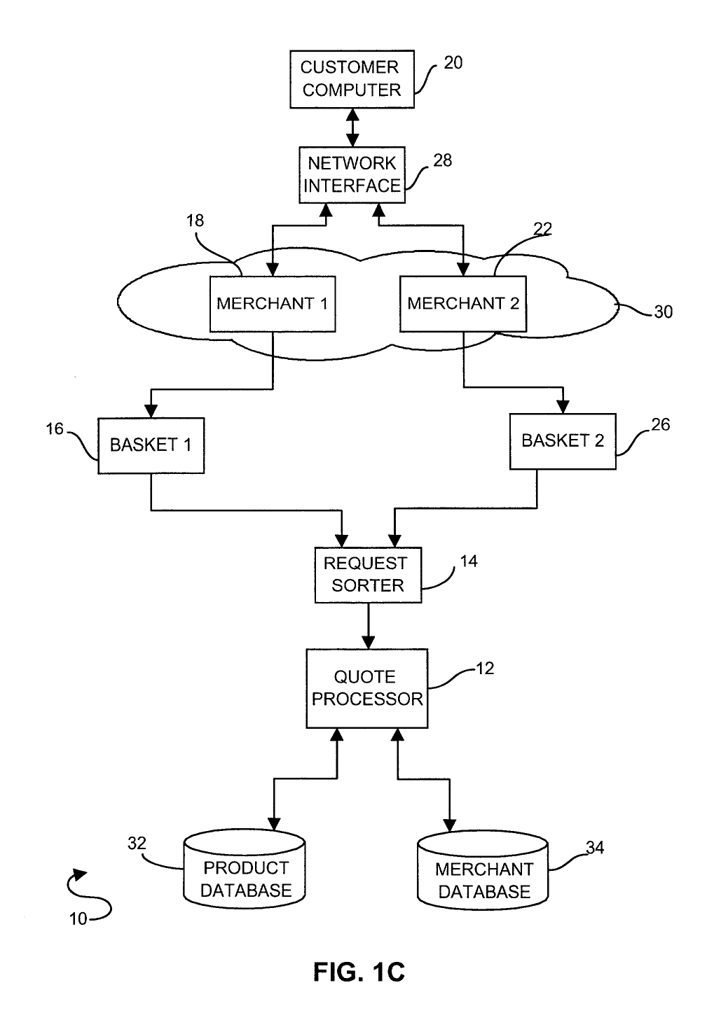

In general, FIGS. 1A to 1C show various electronic commerce system 10 configurations incorporating an international shopping system 12 according to the present invention. FIGS. 1A to 1C show a merchant electronic commerce system 18, 22 containing a shopping basket 16, 24, 26 through which a customer interacting with the merchant system 18, 22 via a customer computer 20 can purchase products offered by the merchant system 18, 22. The products sold via the merchants 18, 22 may be any product, service or manufactured good. Individual merchant systems 18, 22 have separate electronic commerce systems connected over a network 30, such as the Internet, through which a customer computer 20, via a network interface 28 (e.g. a web browser such as Netscape Navigator® or Microsoft Internet Explorer®), can purchase products offered by each merchant system 18, 22. To offer the customer through the customer computer 20 the opportunity to receive a total product cost in a second currency other than the operating currency of the merchant system 18, 22, the basket 16, 24, 26 is in communication with a request sorter 14 and the international shopping system 12.

The customer finds products to purchase from the merchant system 18, 22 and submits these products to the shopping basket 16, 24, 26. When the customer has finished adding products to the basket 16, 24, 26 a price quote request is sent to the basket 16, 24, 26 from the customer computer 20. An indication of the basket's 16, 24, 26 contents is generated and forwarded to the request sorter 14. The request sorter 14 receives the indication of the contents of the basket 16, 24, 26 and prioritizes the customer's request for a price quote for the contents of the basket 16, 24, 26 in a second currency. The prioritization may be according to a number of well known sorting schemes such as first submitted, customer id, etc. When a request associated with the indication of the contents of the basket 16, 24, 26 is ready to be processed, the request is received by the international shopping system 12 where a quote is determined and sent back to the customer computer 20. The international shopping system 12 includes a duty estimation system 110 to provide an estimate of the duty payable for the contents of the basket 16, 24, 26.

The international shopping system 12 interfaces with a number of databases containing information that may be used to enhance a price quote. A product database 32 contains information on products (e.g. most frequently requested price quotes or all possible products, etc.). A merchant database 34 may contain information about the structure of the merchant systems 18, 22. This information may include details on the structure of the product information, allowing the product information to be parsed and relevant details extracted, as well as information on the merchant's 18, 22 system structure (e.g. website structure), policies, quoting formulas, etc. The merchant database 34 might also include instructions for connecting directly to the merchant systems 18, 22.

Referring to FIG. 1A, the single merchant system 18 has their own shopping basket 16 connected, according to method known in the art, to the request sorter 14 and the international shopping system 12 that are all part of the merchant systems 18. FIG. 1B shows the single shopping basket 24 used by multiple merchant systems 18, 22 in communication with the international shopping system 12. The international shopping system 12 and single shopping basket 24 may be part of a service offered by a third party. The shopping basket 24 may be a universal shopping basket such as the universal shopping basket taught in commonly assigned co-pending application titled “Universal Shopping Basket” (United States provisional patent application serial number 60/221,126) hereby incorporated by reference.

FIG. 1C shows multiple merchant systems 18, 22 each having their own shopping basket 16, 26 that is in communication with the single central request sorter 14 and the international shopping system 12. The international shopping system 12 may be a service offered by a third party to which the merchant systems 18, 22 can interface to offer their customers better service.

Although FIGS. 1A to 1C show the international shopping system 12 being a distinct and separate entity form the request sorter 14, the two may also be implemented as part of the same system.

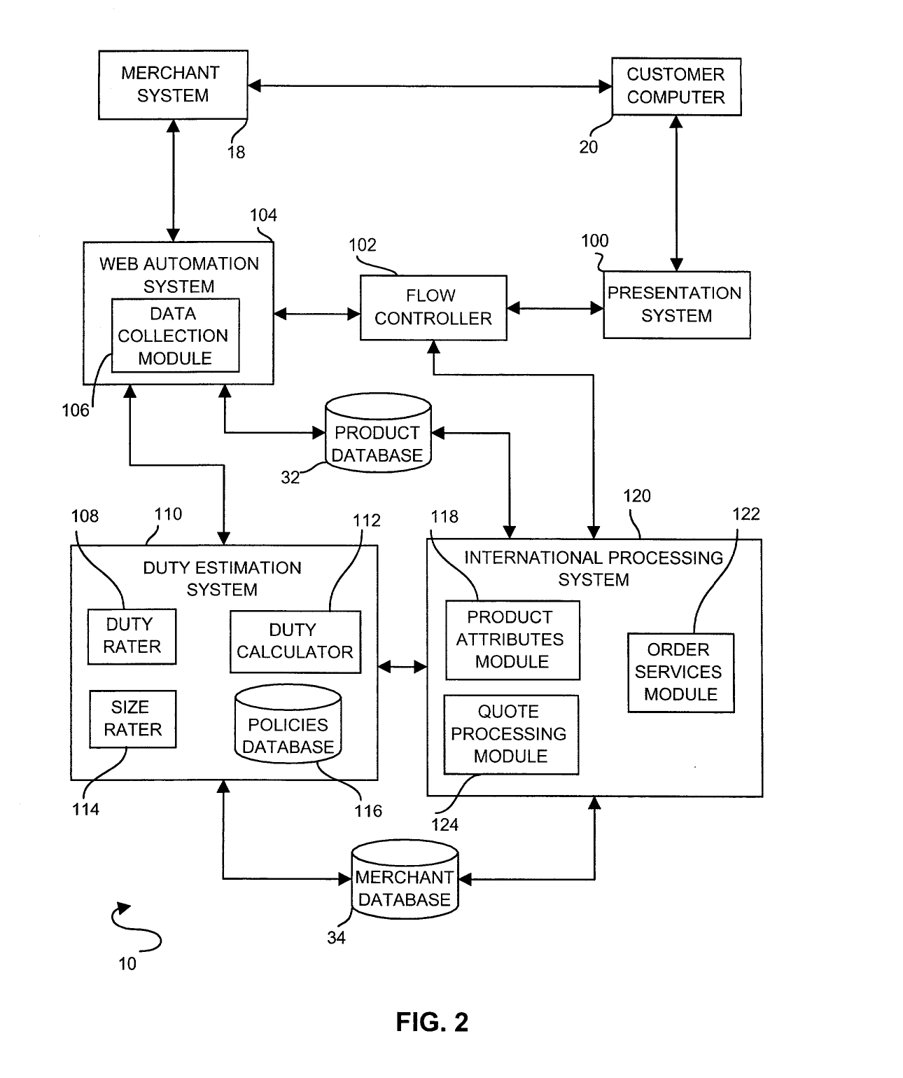

FIG. 2 shows an architecture diagram of an electronic commerce system 10 incorporating the international shopping system 12 according to the present invention. The international shopping system includes a web automation system 104, a flow controller 102, a presentation system 100, a duty estimation system 110, and an international processing system 120.

When customers shop with online merchants, they interact with the merchant's system 18 by traversing various product categories while inquiring about the underlying products and services. When an item of interest is found this item is added to the shopping basket of the customer. From the merchant's system 18 shopping basket, the customer initiates an international checkout process. This checkout may be handled by the international shopping system 12 of the present invention. The international shopping system 12 may interact with the merchant's system 18 using the customer's original session. Various actions may be performed on the merchant's site by the international shopping system 12 via the web automation system 104, the data collected and fed back into the presentation system 100 for display to the customer computer 20.

The web automation system 104 retrieves necessary product information for determining a price quote directly from the merchant's system 18. This can be done with minimal integration effort by the merchant through the use of a data collection module 50 that searches the merchant's system 18 for specific product attributes that are then stored in the product database 32. The process of obtaining product information may occur in a batch process by taking a catalog of all products offered for sale by the merchant and storing this information in the product database 32. This process may be performed via scraping the merchant system 18. Alternatively, this process may occur in real-time as it is needed to fulfill a request. That is, specific product information (e.g. price information) may be collected from the merchant's system 18 as a request for a price quote or international purchase is received. The product information collected in real-time may be dynamic data such as the product price information and static data (e.g. product description and classification) may be obtained in a batch process and stored in the product database 32. After receiving such a request, the product information collected in real-time may be used to obtain corresponding static product information stored in the product database 32. The data collection module 50 may include third party services such as Orsus iGlue/Web.

The duty estimation system 110 provides the means to classify all product information required for international export purposes. Products are categorized according to product categories set by each country. Based on the most frequent countries of origin of that particular product category and duty charges for these countries, a weighted average duty rate is determined and applied to the local currency value for duty cost of the product. Products can be classified according to size by a size rater 114 as well as based on policies and restrictions in a policies database 116. The size rater 114 also determines the likelihood of the package being shipped in a single versus multiple packages as well as the likelihood of multiple products from the same merchant being shipped in a single package. From the product attributes a duty rating is determined by a duty rater 108. This duty rating may be based on the standardized duty rating system developed and used by the G 7 countries, HST. The duty rating can then be translated into a duty amount according to a duty calculator 112. The amount of duty will depend on the country of country into which the product is being shipped.

The flow controller 102 maintains state information across multiple instances of the network interface 28 and across multiple merchant systems 18, 22. There are three different parties in the overall system 10 that need to communicate: the customer computer 20; the merchant system 18, and the international shopping system 12. The flow controller 102 manages communications between these parties.

The customer computer 20 interacts with the merchant system 18 to shop, initiate an international pricing request and also to change shopping basket composition and request repricing. This sequence spans both the merchant's system 18 and the international shopping system 12.

Once the international checkout flow is initiated (price and order), the customer computer 20 may interact directly with the international shopping system 12. Should the customer choose to modify the items in the shopping basket or be forced to do so (e.g. product restrictions, out of stock products, etc.), they are returned to their original state with the merchant's system 18.

While the customer computer 20 interacts with the international shopping system 12, the international shopping system 12 continues its interaction with the merchant system 18 taking steps ahead in the domestic checkout flow, entering information and collecting information.

The presentation system 100 provides a display of the international shopping and checkout process to the customer computer 20. The presentation system 100 and the web automation system 104 act as input/output interfaces, repectively, between the customer computer 20, the international shopping system 12 and the merchant system 18, receiving and sending information between these systems.

The international processing system 120 provides the services and logic for international quote and order preparation. In order to provide a landed cost price, a product attributes module 118 in the international processing system 120 system identifies individual line items that make up an international order. The product attributes module 118 extracts relevant product information from shopping basket information provided via the flow controller 102 from the web automation system 104.

A quote processing module 124 can provide two prices: an exchange price in which unrestricted goods are priced in the local currency of the international customer and a full landed cost price including, which includes the exchange price, plus duties, shipping, handling, and taxes.

An order services module 122 places an order received from the customer computer 20 for products via the web automation system 104 with the merchant system 18. The international processing system 120 handles order payment, status and coordinates the delivery of the order. The order services module 122 analyzes customer and product information to determine if there is sufficient information to place a purchase order directly with the electronic commerce system 18 of the merchant.

The order services module 122 can place an order through the merchant's electronic commerce system 18 in a variety of ways. The order services module 122 can simulate the actions the customer computer 20 would take to purchase a product directly from the merchant 18 via the web automation system 104. This might include actions such as automatically filling out forms and navigating through subsequent information requests and displays. Alternatively, the order services module 122 could purchase a product by interfacing directly with the merchant 18 providing a file containing purchase information such as products to be purchased, shipping information and payment information. This file includes such information as line number, item description, quantity, price, relevant shipping information (e.g. address, etc.) and payment information (e.g. credit card number and expiry date).

The file for purchasing products may be in a flat file or tree structure and may be submitted to the merchant 24, 26 either as part of a batch process or in real-time.

The flow controller 102 receives a request for an international price quote or purchase transaction. This request is sent to the international processing system 120. The international processing system 120 obtains product information from the product database 32. If there is insufficient product data in the product database 32 default information in the merchant database 34 may be used where possible to complete the request.

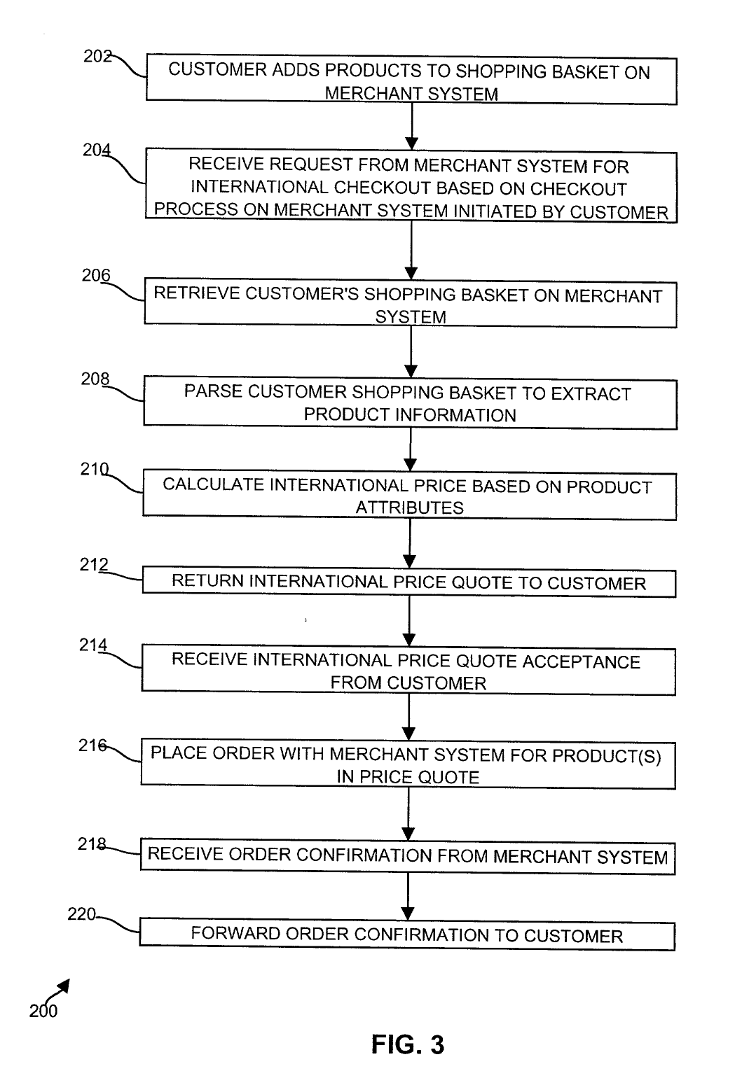

FIG. 3 shows a flow diagram 80 for the electronic commerce system 10 of FIG. 2. The customer browses products on the merchant system 18 in step 202. In an exemplary embodiment of the present invention, during this step interaction with the merchant system 18 may be via HTTP(S) requests, in which case, the merchant system 18 may set HTTP(S) cookies on a customer computer 20, in order to keep track of the state of the shopping process for this particular customer computer 20. During the browsing process (step 202 ), the customer may add product items to a shopping basket on the merchant system 18. If the interactions between the customer computer 20 and the merchant system 18 is via HTTP(S) then HTTP(S) cookies may be set on the customer computer 20.

When the customer wishes to purchase the products in the shopping basket, then a checkout process on the merchant system 18 is initiated in step 204. The merchant system 18 may interface with the international shopping system 12 by requesting an international shopping checkout from the system 12 when appropriate (e.g., requested directly by the customer computer 20, based on customer shipping address, etc.). For an interaction based on HTTP(S) the merchant system 18 provides a link to the international shopping system 12, the activation of which provides the international shopping system 12 with all HTTP(S) cookies that were set by the merchant system 18 on the customer computer 20 as well as merchant identification information. Alternatively, in another exemplary embodiment, a bookmarklet may be used. A bookmarklet is a regular bookmark residing in a list in the network interface of the customer computer 20 (e.g. a browser), instead of specifying a URL (universal resource locator) starting with the characters ‘http://’ or ‘file://’ a bookmarklet specifies a URL starting with the characters ‘javascript:’. As such, the bookmark doesn't contain a regular URL, but a piece of JavaScript code.

This code is executed when the customer computer 20 activates on the bookmark. The context under which the bookmarklet code is executed, is the context associated to the information contained in the network interface at the time when the customer computer 20 activates the bookmark. At the point of execution the customer network interface 28 may contain a page that had been served by the merchant system 18. This implies that the bookmarklet has access to the HTTP(S) cookies set by the merchant system 18. These cookies can be supplied to the international shopping system 12. Since the cookies uniquely identify the customer shopping session, the shopping basket retrieved by the international shopping system 12 is the customer's shopping basket. The international shopping system 12 is able to access the contents of the shopping basket to compute an international price quote and return it to the customer computer 20.

The international shopping system 12 initiates communication with the merchant system 18 to retrieve the customer's shopping basket in step 206. The merchant system 18 returns information on the customer's shopping basket to the international shopping system 12. In the aforementioned exemplary embodiments this can be achieved through the use of obtained cookies.

The international shopping system 12 parses the shopping basket in order to extract the relevant information required to calculate an international price quote in step 208.

The international shopping system 12 calculates the international price quote including relevant shipping, taxes and duties in step 210.

The international shopping system 12 returns this quote back to the customer computer 20 in step 212. This return may be directly from the presentation system 100 or indirectly via the merchant system 18 to provide a system where the customer is unaware of the presence of a separate international shopping system 12.

Acceptance of the quote may be received by the international shopping system 12 from the customer computer 20 in step 214.

The international shopping system 12 will then place an order with the merchant system 18 on behalf or the customer computer 20. Alternatively, the customer 20 may place the order directly with the merchant 18.

Order confirmation from the merchant system 18 is received by the international shopping system 12 and forwarded to the client in steps 216 and 218.

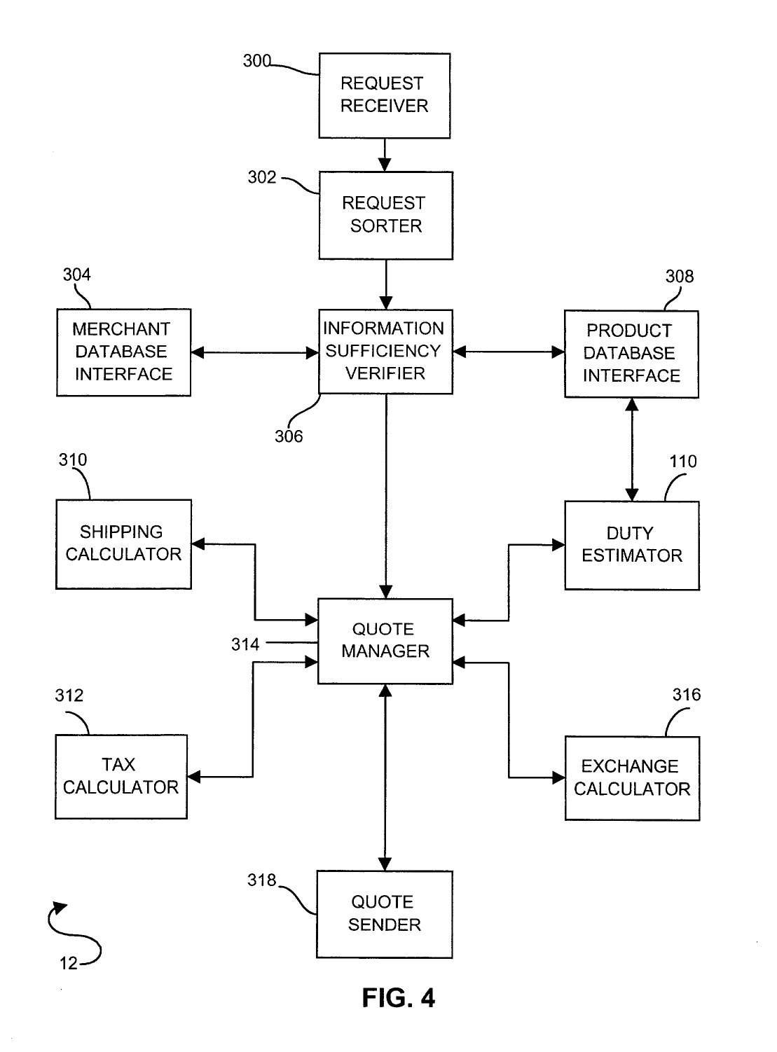

FIG. 4 shows system modules of the international shopping system 12 according to an embodiment of the present invention. A package containing information about all products in the shopping basket 16, 24, 26 and information on the destination of the products as though they were to be bought and shipped is received at a request receiver 300. The package is scanned by a request sorter 302 to determine the priority level of the package. The priority level may be determined by such factors as time received, customer identification, merchant of products in the basket 16, 24, 26, etc. Using the priority level of the package, all incoming packages are sorted and added to a queue of packages waiting to be processed by the international shopping system 12.

The order services module 122 of the international processing system includes a merchant database interface 304. The products attributes module 118 includes a product database interface 308. The quote processing module 124 includes an information sufficiency verifier 306, a shipping calculator 310, a tax calculator 312, an exchange calculator 316 and a quote manager 314.

The information in the package is examined by the information sufficiency verifier 306 to determine if the product information description is sufficient for processing a price quote. The information sufficiency verifier 306, through the product database interface 308, accesses the product database 32 to determine if information on any of the products listed in the package can be found in the database 32. If information is available in the database 32 then this is used to determine if the product information corresponds with information in the database 32. If there is a substantial correlation of data amount and data types between the two pieces of product information then the product information in the package is sufficient for determining a price quote. If the two pieces of product information do not correspond with one another then the discrepancies in the amount and type of data need to be determined. For example, if the product information in the package lists the merchant, type of product and price then details such as color or size are not necessary as these are purchase specific details that do not generally affect price.

Alternatively, the information sufficiency verifier 306 could receive product information in the form as presented by the merchant system 18, 22. In the case where the merchant is offering Internet commerce, the information sufficiency verifier 306 could receive a copy of a hyper text mark-up language (HTML) code that was used by the merchant system 18, 22 to present product information. The information sufficiency verifier 306 parses the HTML code based on a known presentation structure defined in the merchant's database 34, accessed via the merchant database interface 304. The information sufficiency verifier 306 could then extract relevant information necessary for performing a price quote.

The international processing system 120 may include a shipping calculator 310, a quote manager 314, a tax calculator 312, a quote sender 318, and an exchange calculator 316.

The international shopping system 12 prepares a price quote in a local currency for the products. Product and destination information are passed from the information sufficiency verifier 306 to a quote manager 314 where the price quote process is coordinated. The quote manager 314 coordinates passing relevant information to and between a duty estimation system 110, a shipping calculator 310, a tax calculator 312, and an exchange calculator 316. The exchange calculator 316 calculates the price of the product in local currency. The exchange calculator 316 can use currency exchange rates obtained directly from financial institution or can determine currency exchange rates based on statistical trends or exchange rate fluctuations or other timing requirements. The quote manager 314 passes local currency type and product value to the exchange calculator 316 and receives product value in local currency. In the case where a customer receiving a price quote wishes to send the product to a country other than the customer's local country then the local currency is the currency of the customer and the destination country is the country to which the product will be shipped.

The duty estimation system 110 estimates the duty and tariff charges according to country of origin of the product, type of product, and product value. The quote manager 314 supplies the duty estimation system 110 with a product description, destination country and product value in local currency. The duty estimation system 110 gives the quote manager 314 a duty rate to calculate the duty charge on a product or may give the quote manager 314 the entire duty charge. The duty estimation system 110 may also give the quote manager 314 a product type according to the destination country's tariff classification system. This product type can be used in determining taxes and shipping charges. The duty estimation system 110 is connected to the product database interface 308 so that the product database 32 can be searched to determine if the current product is listed in the database 32. If the product is listed in the product database 32 and has an associated duty rate then this is used for calculating the duty.

A shipping calculator 310 determines the shipping charges of a product based on the type of product to determine the size and weight of a package containing the product and the destination address. The quote manager 314 gives the shipping calculator 310 the destination country, the product types, and a customer selected shipping type and receives estimated shipping charges. A tax calculator 312 determines the amount, if any, of tax that must be paid on the product based on the type of product and the shipping destination. The quote manager 314 gives the tax calculator 312 the destination country and product type and receives the tax charges.

The quote manager 314 receives the product value in local currency, duty charges, shipping charges and tax amounts and combines these to determine a total product cost in a customer's local currency. The total product cost is forwarded to a customer computer 20 for review via a quote sender 318. The request receiver 300 via the flow controller 102 and the presentation system 100 and the quote sender 318 act as input/output interfaces between the international shopping system 12 and the customer computer 20, receiving and sending information between the two. The total product cost may be received by a customer computer 20 through notification via the basket 16, 24, 26, or by some other electronic means such as electronic mail, or a customized Internet website listing details of the total product cost. The total product cost may be viewed by the customer through the merchant's system 18 or the international shopping system 12 may communicate directly with the customer computer 20 to display the total product cost.

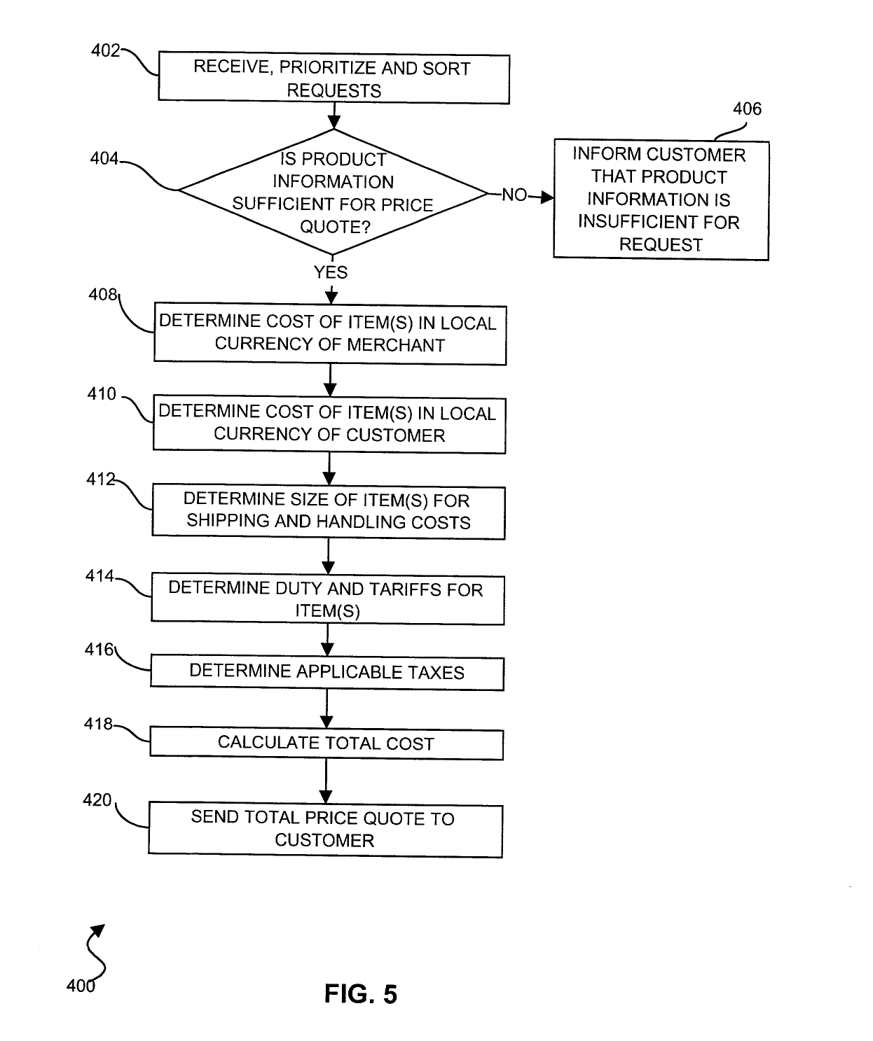

FIG. 5 shows a price quote process 400 of the international shopping system 12 according to an embodiment of the present invention. Product information is received, prioritized and sorted according to priority in step 402. The product information supplied by the shopping basket 16, 24, 26 is examined to determine if there is sufficient information to provide a price quote 404.

If the information is insufficient then the customer computer 20 is informed that not enough information has been provided to complete the price request 406. If there is enough information then the price quote process begins by determining the merchant's price (in the merchant's local currency) for the desired product 408. The merchant's price for the desired product is then converted into local currency 410. The size of the products is determined so that the shipping and handling costs can be calculated 412. The product category of the desired product is determined so that duty and tariffs can be estimated 414. The applicable taxes are calculated 416 and the total cost of the product is determined 418. This cost quote is then sent to the customer 420.

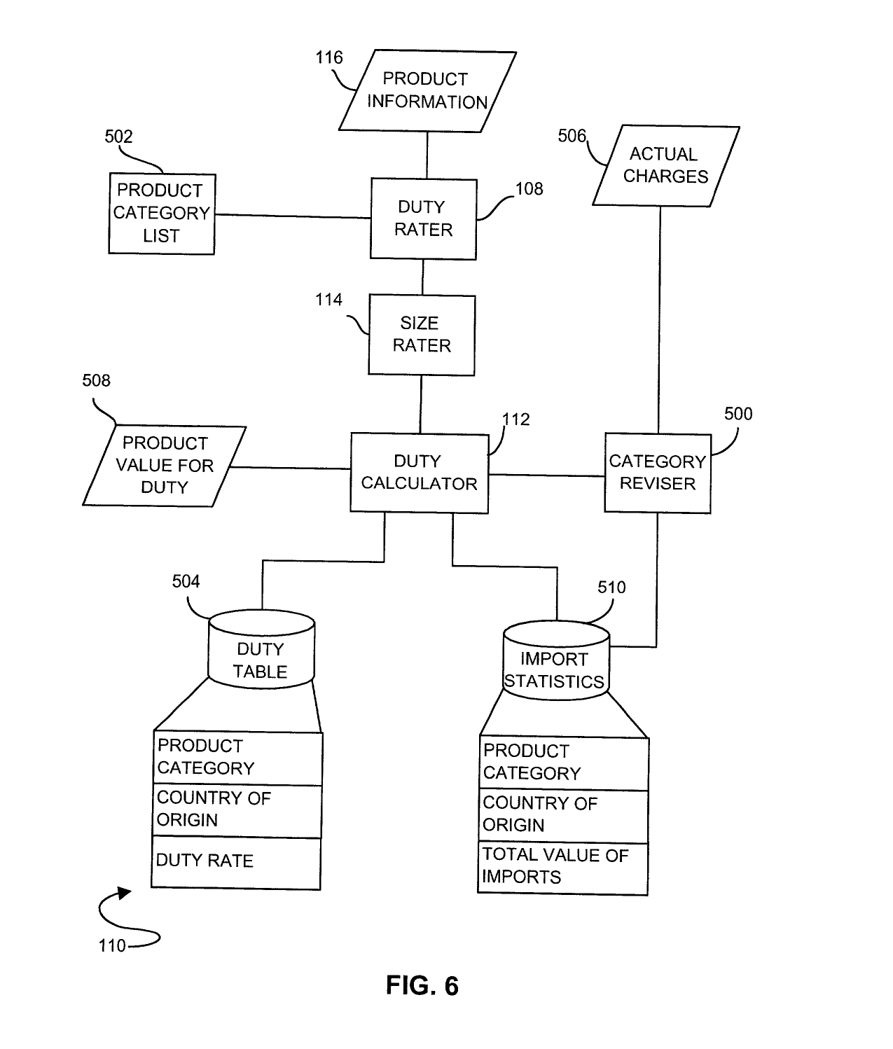

FIG. 6 shows a system diagram of the duty estimation system 110 shown in FIG. 2 according to an embodiment of the present invention. A duty rater 108 receives product information in the product database 32 from the international shopping system 12. This product information includes at least a broad category and other more specific information as necessary, such as women's wool top. The duty rater 108 categorizes the product according to product categories stored in a product category list 502 determined by the importing country's system of tariff classification. A duty table 504 contains information on duty rates for products based on product category and country of origin as determined by an importing country's tariff system. Table 1 is an exemplary duty table.

TABLE 1
Exemplary duty table

| Product Category | Country of Origin | Duty Rate |
|---|---|---|
| Clothing | China | 10% |
| Women's | Mexico | 2% |
| Tops | India | 20% |
| Wool | Italy | 9% |
| Cocoa | United States | 0% |
| Chocolate containing . . . | Germany | 7% |
| added sugar | Switzerland | 5% |
| 90%+ by weight of sugar | United Kingdom | 5% |

The duty category of the product may be used in combination with the policies database 116 to determine other customs or tax related information. For example, based on the duty category of a product import restrictions (e.g. bans and required permits) can be identified for the product. The duty category can also be used to determine and excise taxes or tax exemptions that may apply according to information in the policies database 116.

The size rater 114 determines an approximate size of the product for shipping. This may include an estimate of both the size and the weight of the product. The information from the size rater 114 may be used by the quote processing module 124 to determine shipping insurance for the product as well as the likelihood that the product will be shipping in a single package, or in the same package as other products purchased from the same merchant system.

An import statistics table 510 contains statistical data regarding the total value of imported products by a country of origin for each product category. Table 2 is an exemplary import statistics table.

TABLE 2
Exemplary import statistics table

| | | Total Value of |
|---|---|---|
| Product Category | Country of Origin | Imports |
| Clothing | China | 1,000,000 |
| Women's | Mexico | 250,000 |
| Tops | India | 100,000 |
| Wool | Italy | 70,000 |
| Cocoa | United States | 4,000,000 |
| Chocolate containing . . . | Germany | 800,000 |
| added sugar | Switzerland | 2,200,000 |
| 90%+ by weight of sugar | United Kingdom | 1,200,000 |

The duty calculator 112 determines a duty rate for the product category based on the duty paid on imported products in the same product category by country of origin. The duty paid by country of origin is divided by the correlating value of import, and the resulting rates by country of origin are weighted by import value by country of origin to determine the weighted average duty rate for the product category. Information on the product value for duty in local currency 508 is supplied to the duty calculator 112 so that the duty charges for the product based on the duty rate and product value can be determined. The duty calculator 112 applies the duty rate for the given product category to the product value for duty 508

The duty estimation system 110 has an input for actual charges 506 and a category reviser 500 to allow current import information to be used when determining the estimated duty rate. Actual duty charges 506 for a product are provided to the duty estimation system 110 after a product has been purchased crosses a country's border. This information includes the actual value of the product and the country of origin. The category reviser 500 updates the appropriate information in the import statistics table 510. The relative total value of imports from each country in each product category is maintained to allow product import value ratios per country of origin to remain relatively current.

When a product has already been purchased through the international shopping system 12 the actual duty rate previously applied to the product or the actual shipping charge for that product can be used for a subsequent purchase of the same product.

For those merchant systems offering only one category of products for sale, a specific duty and/or size rate may be applied to all products sold by that merchant. This can be used as an alternative to determining the duty rating and/or size rating for each individual product a merchant offers for sale.

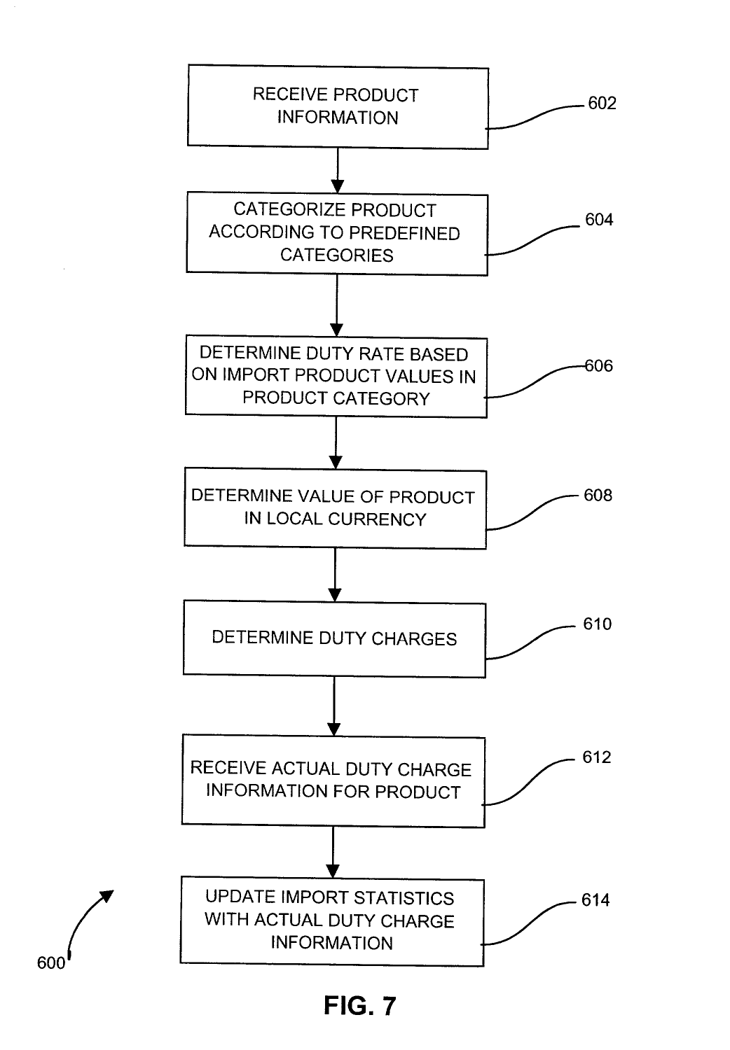

FIG. 7 shows a duty estimation process 600 according to an embodiment of the present invention. Information on a product is received in step 602. The product is categorized in step 604 according to predefined categories as determined by the importing country's system of tariff classification. In step 606 a duty rate is determined. The step 606 of determining duty rates is described below with respect to an exemplary product category. In step 608 the product value in local currency is determined. The duty and tariff charges for that product category based on product value are determined in step 610.

Steps 612 and 614 illustrate additional steps that provide the duty estimation system 110 with a method for dynamically estimating the duty rate based on actual duty paid for imported products. In step 612 information is received on actual duty charged for importing a product. This information includes the product value, duty paid and country of origin. Using this information the import statistics 510 are updated. In this manner a subsequent duty rate calculation will be based on current importing information.

Below is an example of estimated duty charges using the process outlined in FIG. 3. The product is a women's sweater being shipped to Canada and having a United States dollar value of $45.

Product Category: Clothing, Women, Tops, Wool

In this example, shown in Table 3, a weighted average using the product value and countries of origin are used in determining the duty rate for women's wool tops that are imported into Canada. However, another method of determining the duty rate may be used, such as a straight average of duty rates, an average of the duty paid, etc.

TABLE 3
Country of Origin and import statistics in the product
category coming from the following countries:

| | Import Statistics | | | |
|---|---|---|---|---|
| | | | | Weighted Duty |
| Country | Value of | Duty | Effective | Rate Based on |
| of Origin: | Imports | Paid | Rate | Value of Imports |
| China | 1,000,000 | 100,000 | 10% | $\frac{\text{1,000,000}}{\text{1,420,000}} \times 10 \% = 7.0 \%$ |
| Mexico | 250,000 | 5,000 | 2% | $\frac{\text{250,000}}{\text{1,420,000}} \times 2 \% = 0.4 \%$ |
| India | 100,000 | 20,000 | 20% | $\frac{\text{100,000}}{\text{1,420,000}} \times 20 \% = 1.4 \%$ |
| Italy | 70,000 | 6,000 | 9% | $\frac{\text{70,000}}{\text{1,420,000}} \times 9 \% = 0.4 \%$ |
| TOTAL | 1,420,000 | 131,000 | | 9.2% |

The duty charges for a women's wool top based on the weighted duty rate of 9.2%, and assuming an exchange rate of 50%, would be:

Duty Calculation=US$45.00(Product Price)×1.50(Exchange Rate)=CD$67.50(Value for Duty)×9.2% (Duty Rate)=CD$6.21(Duty Charge)

In summary, the present invention provides a system and method for determining a total cost of a foreign originating product in a customer's local currency. The present invention allows a customer to shop via electronic methods regardless of a merchant's location country and receive the total final cost of the product in the customer's local currency. Currency exchange, duties and tariffs, taxes and shipping are included in the given total cost of the product. A duty estimation system of the present invention estimates duty charges prior to a product crossing an international border.

It is apparent to one skilled in the art that numerous modifications and departures from the specific embodiments described herein may be made without departing from the spirit and scope of the invention.

1. An international shopping system in communication with an electronic commerce system operating in a first currency and offering a product for purchase, the international shopping system providing a cost in a second currency for the product to be imported into a destination country, the international shopping system comprising:
an input/output interface for receiving a request for the cost of the product in the second currency and providing the cost of the product in the second currency in response to the request;
a commerce system interface to the electronic commerce system for obtaining information about the product in response to the request;
a product cost calculation system comprising:
a quote processor for establishing the cost in the second currency for the product to be imported; and
an importing cost determination module in communication with the quote processor for determining an import cost for the product to be imported into the destination country based on information about the product obtained from the electronic commerce system, the importing cost determination module providing the quote processor with the import cost.

2. The international shopping system according to claim 1 wherein the commerce system interface includes:
a product data module for obtaining product data from the electronic commerce system;
a product data address module for obtaining a location address for the product data on the electronic commerce system.

3. The international shopping system according to claim 2 wherein the product information on the electronic commerce system is in the form of a web page and
wherein the product data module includes a markup code module for obtaining a markup code file containing the product data from the electronic commerce system; and
wherein the product data address module includes a Universal Resource Location (URL) module for obtaining a URL identifying the location of the product data on the electronic commerce system

4. The international shopping system according to claim 1 further including
a commerce system database containing information for communicating with and purchasing products from the electronic commerce system.

5. The international shopping system according to claim 1 further including:
a product database containing information about a plurality of products, the product offered for purchase by the electronic commerce system being one of the plurality of products;
wherein the product information obtained by the commerce system interface is stored in the product database.

6. The international shopping system according to claim 1 further including:
a flow controller for facilitating communications between the commerce system interface, the output interface and the purchase cost calculation system.

7. The international shopping system according to claim 1 further including:
an information sufficiency verifying module for analyzing the information from the electronic commerce system about the product to determine if there is sufficient information to process the request and extracting product data relevant to the request for the product cost calculation system.

9. The international shopping system according to claim 1 wherein the importing cost determination module comprises:
a duty estimation module for estimating a duty charge for the product based on product data and the destination country;
a tax calculator for determining a tax cost for the product from the destination country; and
a shipping calculator for determining a shipping cost for the product to the destination country.

10. The international shopping system according to claim 9 wherein the duty estimation module comprises:
a product categorizer for determining a product category for the product being imported based on product information from the electronic commerce system;
a duty estimator for estimating the duty rate for the product based on the product category;
a duty charge processor for calculating an estimated duty charge based on the estimated duty rate and a value of the product.

11. The international shopping system according to claim 1 wherein the quote processor comprises:
an exchange calculator for determining a value for the product in the second currency based on the product data from the electronic commerce system;
a quote manager for coordinating establishing the cost in the second currency for the product to be imported, the quote manager receiving information from the duty estimation module, the tax calculator, the shipping calculator and the exchange calculator.

12. The international shopping system according to claim 1 wherein the product cost calculation system further includes:
a purchasing module for purchasing the product from the electronic commerce system.

13. A method for providing a cost in a second currency of a product being imported into a destination country, the product being offered for sale by an electronic commerce system operating in a first currency, the method comprising:
receiving a request for the cost of the product in the second currency;
obtaining information about the product from the electronic commerce system;
determining an import cost for the product to be imported into the destination country based on information about the product obtained from the electronic commerce system;
establishing a total cost for the product in the second currency; and
providing the cost of the product in the second currency.

14. The method according to claim 13 wherein the step of obtaining information about the product includes:
obtaining product data from the electronic commerce system; and
obtaining a location address for the product data on the electronic commerce system.

15. The method according to claim 14 wherein the step of obtaining product data includes obtaining a markup code file containing product data from the electronic commerce system; and
wherein the step of obtaining a location address for the product data includes obtaining a Universal Resource Locator (URL) identifying the location of the product data on the electronic commerce system.

16. The method according to claim 13 further including:
storing information about the product obtained from the electronic commerce system in a database.

17. The method according to claim 13 further including:
determining if the information about the product is sufficient to process the request; and
extracting the information about the product relevant to the request if the information about the product is sufficient.

18. The method according to claim 13 wherein the step of determining an import cost includes:
estimating a duty charge for the product based on the information about the product and the destination country;
determining a tax cost for the product from the destination country; and
determining a shipping cost for the product to the destination country.

19. The method according to claim 18 wherein the step of estimating a duty charge includes:
determining a product category for the product being imported based on the information about the product;
estimating the duty rate for the product based on the product category;
calculating an estimated duty charge based on the estimated duty rate and a value of the product.

20. The method according to claim 13 wherein the step of establishing a total cost includes:
determining a value for the product in the second currency based on the product data from the electronic commerce system;
coordinating establishing the cost in the second currency for the product to be imported based on the duty charge, the tax cost and the shipping cost.

21. The method according to claim 13 further including:
purchasing the product from the electronic commerce system.

22. A computer readable medium having stored thereon computer-executable instructions for providing a cost in a second currency of a product being imported into a destination country, the product being offered for sale by an electronic commerce system operating in a first currency, the computer-executable instructions performing the steps comprising:
receiving a request for the cost of the product in the second currency;
obtaining information about the product from the electronic commerce system;
determining an import cost for the product to be imported into the destination country based on information about the product obtained from the electronic commerce system;
establishing a total cost for the product in the second currency; and
providing the cost of the product in the second currency.

23. The computer-readable medium according to claim 22 wherein the step of obtaining information about the product includes:
obtaining product data from the electronic commerce system; and
obtaining a location address for the product data on the electronic commerce system.

24. The computer-readable medium according to claim 23 wherein the step of obtaining product data includes obtaining a markup code file containing product data from the electronic commerce system; and
wherein the step of obtaining a location address for the product data includes obtaining a Universal Resource Locator (URL) identifying the location of the product data on the electronic commerce system.

25. The computer-readable medium according to claim 22 further including:
storing information about the product obtained from the electronic commerce system in a database.

26. The computer-readable medium according to claim 22 further including:
determining if the information about the product is sufficient to process the request; and
extracting the information about the product relevant to the request if the information about the product is sufficient.

27. The computer-readable medium according to claim 22 wherein the step of determining an import cost includes:
estimating a duty charge for the product based on the information about the product and the destination country;
determining a tax cost for the product from the destination country; and
determining a shipping cost for the product to the destination country.

28. The method according to claim 27 wherein the step of estimating a duty charge includes:
determining a product category for the product being imported based on the information about the product;
estimating the duty rate for the product based on the product category;
calculating an estimated duty charge based on the estimated duty rate and a value of the product.

29. The method according to claim 22 wherein the step of establishing a total cost includes:
determining a value for the product in the second currency based on the product data from the electronic commerce system;
coordinating establishing the cost in the second currency for the product to be imported based on the duty charge, the tax cost and the shipping cost.

30. The method according to claim 22 further including:
purchasing the product from the electronic commerce system.
